(19) United States
(12) Patent Application Publication
(10) Pub. No.: US 2020/0207496 A1
(43) Pub. Date: Jul. 2, 2020

(54) Facility for Producing Containers by Means of Thermoforming

(71) Applicant: ERCA, Les Ulis (FR)

(72) Inventors: Dominique SCHWAB, Versailles (FR); Timothy COOPER, L'Hay Les Roses (FR)

(73) Assignee: ERCA, Les Ulis (FR)

(21) Appl. No.: 16/613,612

(22) PCT Filed: May 23, 2018
(86) PCT No.: PCT/FR2018/051226

§ 371 Date: Nov. 14, 2019

(30) Foreign Application Priority Data
May 24, 2017 (FR) 1754615

(51) Int. Cl. B65B 47/04; B29C 51/26; B29C 51/46; B65B 3/02; B65B 3/04; B65B 7/28; B65B 41/04; B65B 47/02; B65B 57/08; B65B 61/06; B65G 54/02; B65G 43/00

(52) U.S. Cl. CPC B65B 47/04; B29C 51/262; B29C 51/46; B65B 3/022; B65B 3/04; B65B 7/2814; B29L 2031/712; B65B 47/02; B65B 57/08; B65B 61/06; B65G 54/02; B65G 43/00; B65B 41/04

(57) ABSTRACT

The facility comprises a plurality of processing stations (14A, 14B, 14C, 16, 18, 20, 20, 22, 24) for producing containers from a thermoplastic substrate. The facility comprises a plurality of basic conveyors (30) that cooperate with a travel track (32), for the purpose of conveying the sheets to the processing stations, the respective movements of the basic conveyors being controlled according to respective movement control commands generated by a control unit (ECU).

The present disclosure relates to an installation for producing containers by thermoforming, comprising conveying means able to be controlled by a control unit for driving a thermoplastic substrate in a series of processing stations along a conveying direction, the processing stations comprising at least one station for heating the substrate and one station for thermoforming containers in the heated substrate, each processing station defining a processing length measured in the conveying direction.

This type of installation is known, for example from document FR 2 839 465. The installation can be used not only for the production of containers, but also for their filling and their closing (the installation is then called “form-fill-seal” type installation), in which case the processing stations may further comprise a station for filling and a station for closing the containers, particularly by lidding. The thermoplastic substrate may be a continuous strip, or sheets or wafers. Conventionally, this substrate is driven step by step in the various processing stations. Thus, the substrate(s) present at a given time in a station are conventionally all displaced at the same speed, or all immobilized at the same time in the processing stations, to undergo therein the desired processing. The driving means may for example be a linear scrolling strip, or a carousel.

These installations are satisfactory, but the production rates are strictly related to the parking time in the station requiring the longest processing. In other words, even when the processing in a station can be carried out over a very short period of time, the substrate remains there during the entirety of the stop phase, whose duration is that of the longest processing. Moreover, the duration of execution of the phases of movement of the substrate(s) is also set to the situation that requires the slowest movement. Particularly, if the movement of the thermoformed containers must be carried out with more caution than the movement of the substrate prior to this thermoforming, the two movements will however be carried out at the same speed and over the same period of time. In addition, when the installation relates not only to the production of containers, but also to their filling, the phase of movement of the filled containers must be carried out with more caution to avoid excessive agitation of the product contained in the containers which, especially when this product is liquid or pasty, might cause splashes around the containers.

In summary, the installations of the state of the art are subject to strong constraints in terms of production rates, these rates being conventionally set to the processing or movement phase which must be carried out with as much time and as much caution as possible.

The present disclosure aims at improving this state of the art by overcoming at least substantially the aforementioned drawbacks.

Thus, according to a first aspect, the present disclosure relates to an installation for producing containers by thermoforming, comprising conveying means able to be controlled by a control unit for driving a thermoplastic substrate in a series of processing stations along a conveying direction, the processing stations comprising at least one station for heating the substrate and one station for thermoforming containers in the heated substrate, each processing station defining a processing length measured in the conveying direction, installation in which the conveying means comprise a plurality of basic conveyors each configured to drive, in the processing stations, a basic sheet of substrate whose length, measured in the conveying direction, is substantially equal to the processing length, the basic conveyors cooperating with a travel track and their respective movements being controlled according to respective movement control instructions generated by the control unit.

Optionally, the processing stations further comprise a station for filling containers.

According to the present disclosure, each basic sheet of substrate is successively driven in the various processing stations of the installation by the basic conveyor carrying it. The movements of this basic conveyor are controlled specifically by taking into account the processing or movement phase considered. For example, between the processing phases that precede the thermoforming of the containers, the phase of movement of the sheet can be very fast, that is to say the acceleration, speed and deceleration can be high. However, the basic sheet in which containers have already been formed must possibly be displaced with more caution, so that the acceleration and deceleration are milder, the maximum speed being possibly lower. This is particularly the case for the phase of movement of the filled containers, when the installation comprises, among the processing stations, a filling station. Consequently, the installation can be controlled so that the parking times in the different processing stations take these constraints into account. Particularly, by taking into account the possibility of displacing the basic sheets more rapidly between the heating station and the thermoforming station than downstream of the thermoforming station, the sheets can be parked longer in the heating station than in the thermoforming station, so as to optimize heating. This allows for example limiting the energy required for the heating, or reducing the number of heating stations. When the installation includes a station for filling containers, the filling can be carried out very quickly, and the conveyor which carries the basic sheet in which the containers have been thermoformed and filled can then be displaced slowly, while the beginning of its movement occurs before the beginning of the movement of the basic sheet which, at the same pitch, is in the heating station.

Optionally, the track forms a loop comprising a forward path on which the basic conveyors circulate to successively place the basic sheets they convey in the processing stations, and a backward path, on which the basic conveyors circulate to return to the upstream of the installation.

The movements of the basic conveyors on the forward path are controlled so as to allow the processing phases in the different processing stations. These movements are therefore sequential and their total duration depends on the processing stations and on the processing operations that must be performed therein. However, on the backward path, the conveyors can be displaced much more quickly since they undergo therein in principle no processing other than, possibly, a cleaning to make sure that no basic sheet debris remained trapped therein. This makes it possible in particular to limit the number of basic conveyors, since, while on the forward path, a conveyor is required for each of the processing stations, it may be sufficient on the backward path, which nevertheless forms in principle the same length as the forward path, to have only one or two conveyors.

Optionally, the installation comprises means for locating the position of the basic conveyors with respect to the processing stations.

According to a first example, each processing station has a detector configured to generate information on the position, relative to the considered processing station, of a basic sheet conveyed by a given basic conveyor, the control unit being configured to generate, based on said position information, an instruction for controlling the movement of said given basic conveyor.

According to a second example, each basic conveyor has a detector configured to generate information on the position of the considered basic conveyor relative to a given processing station, the control unit being configured to generate, based on said position information, an instruction for controlling the movement of said considered conveyor.

These first and second examples of position location means, can be provided in combination on the same installation, or only one of them can be provided

Optionally, the movement control instructions comprise movement speed instructions and/or acceleration instructions.

Optionally, each basic conveyor is equipped with a basic motorization, the movement control instructions comprising instructions for activating the basic motorizations of the respective basic conveyors.

For example, the basic motorization comprises a first part of an electric motor, particularly of the linear servomotor type, and the track is equipped with a multiplicity of magnetic windings, selectively powered by the control unit and forming the second part of the electric motor.

Optionally, the processing stations are disposed on a same side along the track.

Optionally, the processing stations are supported by supports, also disposed on said same side of the track.

In this case, the processing stations can be easily removed from the track, for example for maintenance or replacement.

Optionally, the installation comprises an input station having means for feeding a strip of thermoplastic material along a supply direction transverse to the conveying direction and means for cutting, in said strip, basic sheets whose length is defined by the width of the strip of thermoplastic material.

The space requirement of the installation according to the conveying direction is thus limited.

Optionally, the basic conveyors comprise grippers configured to grip a single gripping edge of the basic sheets, the grippers of the basic conveyors conveying the basic sheets being all located on the same side of the track. Particularly, when the track is linear, these grippers can be aligned.

In other words, the basic sheets can be gripped in a “cantilevered” manner and the conveyors are all on the same side of these sheets, so that the maintenance and possible replacement operations are facilitated.

Optionally, the installation comprises a support for the basic sheets defining a work plane in the different processing stations.

Optionally, the processing stations further comprise a station for filling the thermoformed containers and a station for closing the containers by application of lidding sheets on the basic sheets including the thermoformed containers, the installation further comprising an upstream cutting tool configured to cut out waste areas in the basic sheets prior to the application of the lidding sheets, and a downstream cutting tool configured to cut out corresponding waste areas in the lidding sheets.

In this case, it is possible to separate the waste cut out in the basic sheets, which are made of thermoplastic material, and those cut out in the lidding sheets, which are in another material. This facilitates the recovery of this waste and the possible recycling.

Optionally, the installation comprises means for feeding a strip of lidding material along a direction transverse to the conveying direction and means for cutting the lidding sheets in said strip of lidding material, so that the length of the lidding sheets is defined by the width of the strip of lidding material.

The lidding sheets are thus made in a simple manner compatible with a reduced space requirement along the direction of advance.

Optionally, the upstream cutting tool is part of the input station and, optionally, is part of the same cutting station as the means for cutting the basic sheets.

The present disclosure will be better understood upon reading the detailed following description, which refers, by way of example of embodiment, to the appended drawings wherein:

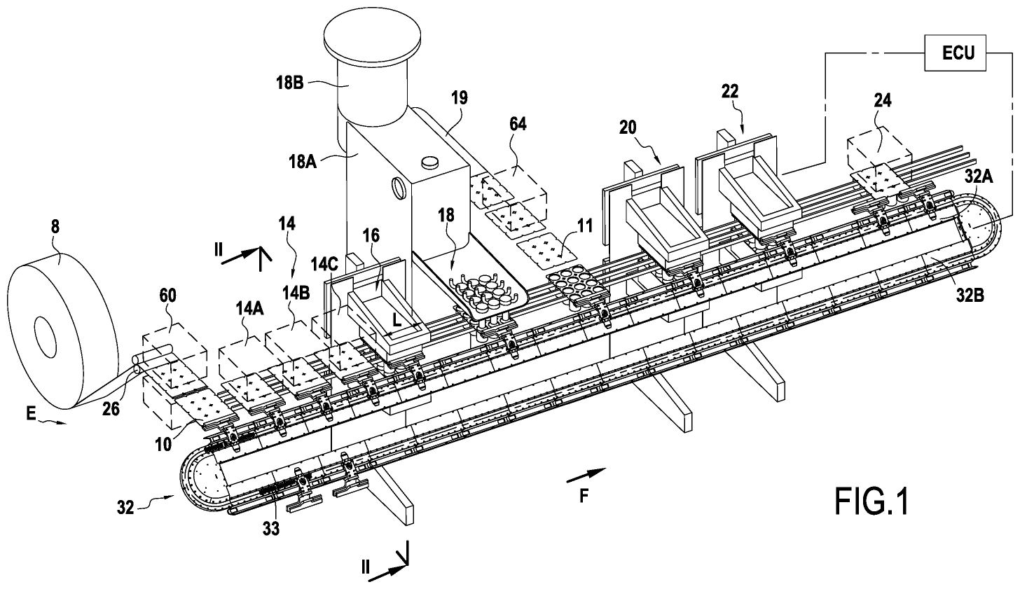

FIG. 1 is a perspective view of an installation according to this the present disclosure;

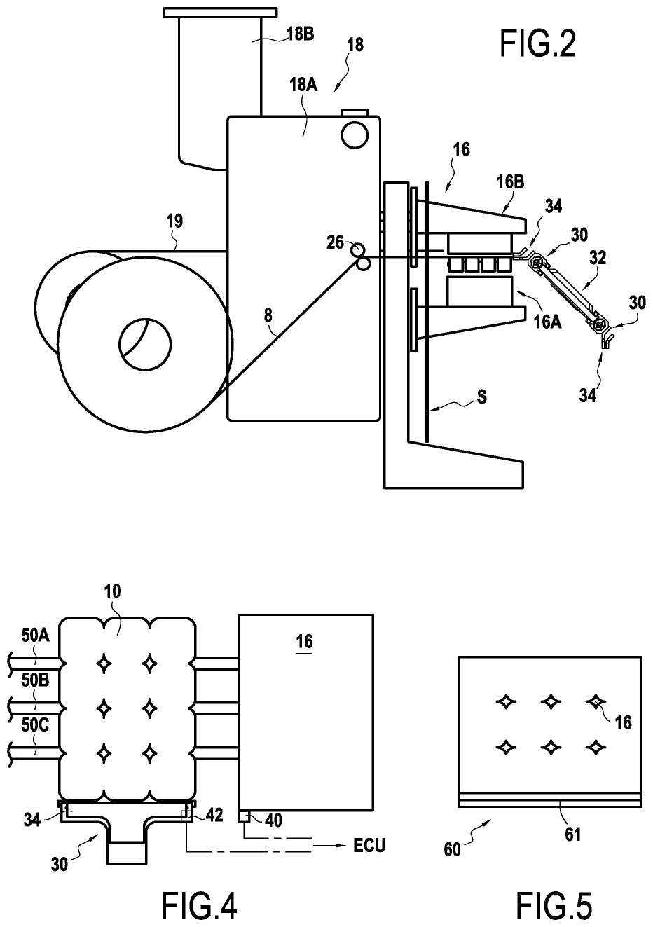

FIG. 2 is a sectional view in a transverse plane II represented in FIG. 1;

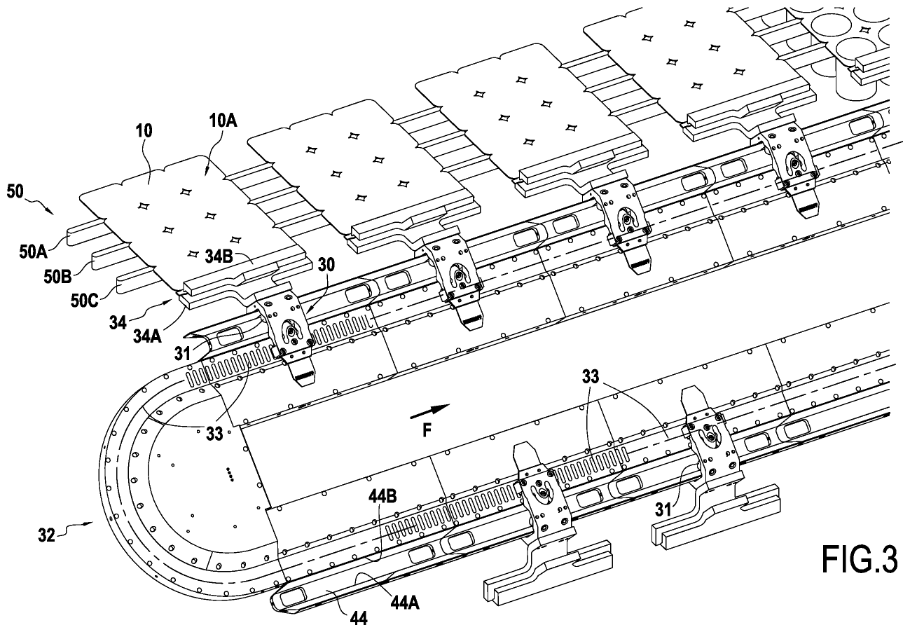

FIG. 3 shows part of the installation of FIG. 1;

FIG. 4 is a top view of part of the installation; and

FIG. 5 is a bottom view of the tool for cutting the basic sheets.

The installation represented in FIG. 1 comprises a plurality of processing stations through which the basic sheets of thermoplastic substrate 10 are driven step by step. Considered successively in the conveying direction F, these processing stations comprise heating stations 14A, 14B and 14C (there may be fewer or more heating stations), a station 16 for thermoforming containers, a station 18 for filling thermoformed containers, a station 20 for closing the containers by application of lidding sheets 11 on the basic sheets including the thermoformed and filled containers, a station 22 for precutting the containers in groups of one or several containers, and a station 24 for discharging the thermoformed and thus group-packaged containers.

As best seen in FIG. 2, the thermoforming station 16 includes, in a conventional manner, a mold block 16A, and a piston block 16B, this piston block comprising as many thermoforming pistons as the mold block comprises thermoforming chambers. Of course, the installation may further comprise additional stations or tools, such as cleaning stations, or strapping tools, for example disposed in the area of the thermoforming station, for strapping or labeling the containers, particularly by disposing straps or labels in the thermoforming chambers prior to thermoforming. The filling station for its part comprises one or several tanks 18A, 18B of products to be disposed in the containers, for example a pasty product such as yogurt, and a liquid product such as coulis. This filling station also comprises devices for dosing the product(s) to be disposed in the containers.

The installation also comprises means 26 for feeding a thermoplastic strip 8 in which the basic sheets 10 are cut, as well as the means for feeding a lidding strip 19 in which the lidding sheets 11 are cut. The different basic sheets 10 are driven into the different stations for processing the installation by basic conveyors 30, better visible in FIG. 3. These conveyors move by cooperating with a travel track 32. It can be seen from the FIGS. 1 and 3 that this track forms a loop, with a forward path 32A on which the basic conveyors 30 circulate to successively place the basic sheets 10 they convey in the processing stations, and a backward path 32B allowing the basic conveyors 30 to return in an idle mode to their point of departure, upstream of the installation.

Each basic conveyor 30 comprises a gripper 34 that grips a basic sheet upstream of the station, to drive it downstream. As seen in particular in FIGS. 2 and 3, the grippers 34 comprise two jaws, respectively 34A and 34B that can be opened to release a sheet or closed to pinch it therebetween.

Each of the basic conveyors 30 includes its own basic motorization. The installation comprises a control unit ECU which controls the activation of the basic motorizations of the different basic conveyors. In this case, the basic conveyors can be in particular driven using linear electric motors of the type servomotor drivable according to their positions on the track 32, for example as described in documents US 20150008768, US 20150048693 or US 20160325761.

The respective components of these linear motors are respectively carried by the basic conveyors and by the travel track. Thus, as can be seen particularly in FIG. 3, the track 32 comprises a multiplicity of magnetic windings 33 that are distributed over the entire length of the track and connected to a printed circuit whose contacts are selectively supplied with alternating current using the control unit ECU (for the simplicity of the drawing, this multiplicity of windings is only partially schematized). For their part, the basic conveyors 30 carry permanent magnets. Thus, when a conveyor is facing an electrically powered magnetic winding 33, its permanent magnet is excited by this winding, so as to generate mechanical thrust energy. It is understood that because of the large number of magnetic windings 33 present on the track, the position and the speed of movement of each basic conveyor can be set very finely depending on the power supplies of these different windings. The magnetic windings 33 constitute units for exciting the permanent magnets of the basic conveyors, these windings being selectively powered by the control unit ECU to activate the permanent magnets that form basic motorizations for the basic conveyors.

Depending on the power supply of the windings, the speed of movement, the acceleration and the deceleration are monitored.

The installation comprises means for locating the position of the basic conveyors 30 with respect to the different processing stations. An example for such means is represented in FIG. 4. This figure shows a basic sheet 10 located at the approach of a processing station which is, for example, the thermoforming station 16. This sheet is conveyed by a partially represented basic conveyor 30, with its gripper 34 maintaining an edge of the sheet.

The processing station comprises a detector 40 which is configured to generate information on the position, relative to this station 16, of the basic sheet 10 which achieves its approach. Moreover, the basic conveyor 30 may also have a detector 42 which is configured to generate information on the position of this basic conveyor 30 relative to the processing station 16. In the example represented, the detector 40 is located at the upstream end of the processing station 16, and detects the basic conveyor when the downstream edge thereof reaches the right of the detector 40. The detector 40 may for example be a photoelectric cell, and the detector 42 may be a passive element reflecting the signal sent by the cell. As indicated, any other detection means can be provided, the two detectors may be optionally active and placed in different places. For example, the detector 40 may be further disposed upstream with respect to the station 16, so that it detects the approach of the conveyor 30, before the latter actually reaches the upstream edge of this station. It could also be provided that the processing station is equipped with a photoelectric cell with an emitter and a reflective element between which, in the absence of basic sheet in this station, a beam prevails, this beam being interrupted upon arrival of a basic sheet 10. In any case, regardless of the detection means used, it is possible to make sure that the latter communicates with the control unit ECU so that the latter generates a control instruction at the motorization of the basic conveyor. Particularly, when the approach of a basic conveyor carrying a basic sheet is detected, the motorization is slowed down and then stopped. As indicated, considering, in the example represented, the multiplicity of magnetic windings 33 for exciting the basic motorizations of the basic conveyors, the position of these can be managed in an extremely accurate manner, relative to each of the processing stations. In addition, the magnetic windings 33 disposed between processing stations between which the basic sheets can be displaced very quickly, for example upstream of the thermoforming station 16, can be powered to control a high speed of movement for the basic conveyors switching to the right of these windings. However, the magnetic windings 33 disposed on the sections on which the movement is to be slower, particularly at the outlet of the filling station 18, can be powered so as to generate a slower speed and a milder acceleration/deceleration.

Similarly, when a work step has been performed, and when it is necessary to displace the basic conveyors toward the processing stations located downstream, the corresponding magnetic windings can be powered differently. Particularly, the filling operation in the filling station 18 is extremely fast and, as indicated, the speed of movement downstream of this station must be slow. However, the thermoforming operation in the thermoforming station 16 can be relatively slow, and it is desirable to make the parking of a basic sheet last as long as possible in a heating station 14A, 14B or 14C to maximize heating. Consequently, the basic conveyors 30 carrying basic sheets leaving the heating and thermoforming stations can be set in motion only after the basic conveyors located downstream of the filling station are set in motion. This is possible thanks to the fact that the different magnetic windings 33 are powered separately from each other, according to their respective positions with respect to the different processing stations.

The basic conveyors 30 may comprise bearing rollers 31 which cooperate with the running tracks to guide the movements of these basic conveyors. For example, as seen in FIG. 3, the track 32 may, along the windings 33, be equipped with a portion of the running track 44 having one or more sliding rails. In this case, two sliding rails, respectively 44A and 44B, are formed by the edges of this running track. FIG. 3 shows bearing rollers 31 of the basic conveyors 30 which cooperate with the outer rail 44A of the running track 44. For simplicity of the drawing, the running track 44 is not represented in the curved part of the track 42, as its geometry may be slightly different at this location, but this track can of course be present to also guide the movement of basic conveyors in this area.

In the description above, the motorization of the basic conveyors is carried out by linear electric motors whose permanent magnet parts form basic motorizations respectively carried by the different basic conveyors, and whose winding portions are carried by the track 32 and electrically powered selectively, so that at each passage of a basic conveyor to the right of a magnetic winding 33, there is formed an electric motor having as components this winding and the permanent magnet of this basic conveyor. However, it could be conceived that each conveyor carries a complete motor, and that the track has a multiplicity of units for powering these motors, whether it is a contact or a contactless power supply.

The control unit ECU generally manages the activation of the various elements of the installation. As indicated, it manages the activation of the basic motorizations of the various basic conveyors 30. Moreover, it manages the closing/opening sequences of the grippers 34. For example, the closing of the jaws 34A and 34B of these grippers can be controlled by powering electromagnets, one jaw or two jaws of which can be provided. The control unit ECU also manages the activation of the various elements of the processing stations, particularly the sequences of opening/closing and movement of the thermoforming pistons of the thermoforming station, and the sequences of opening/closing of the product supply nozzles of the filling station, as well as the movements of the knives of the cutting and pre-cutting stations.

It can be seen in the figures that the different processing stations are all disposed on the same side of the track 32. This allows facilitating the maintenance operations. Particularly, a processing station can be easily removed from the track by being displaced laterally relative to the latter, in order to allow replacing it with another processing station, or performing maintenance operations therein. It is also noted that, given the possibility of activating at will the motorizations of the different basic conveyors, the spaces between the different processing stations may slightly vary. This makes it possible, without complex operation, to parameterize the installation in order to process the different processing lengths therein.

It can be seen in the figures, particularly in FIG. 1, that all the different processing stations define the same processing length L measured in the conveying direction. The processing length L is the basic sheet length 10 that can be simultaneously processed in the same processing station. It corresponds to the length of the basic sheets 10 measured in the direction F.

For example, the represented installation makes it possible to produce simultaneously three rows of four containers. The three rows are located relative to each other in the conveying direction F, in which the length L is measured, and the four rows being measured in the direction of the width of the basic sheets. From a same installation, it can be easy to produce a larger number of rows, by removing one or more of the processing stations to replace them with others.

It can be seen that the processing stations are disposed on supports S (referenced in FIG. 2) which are also disposed on the same side of the track. Thus, all the maintenance operations can be performed on these supports without interfering with the conveying path. As can be seen particularly in FIG. 2, the tools of the various processing stations, in this case the mold block 16A and the counter-mold block 16B, can be disposed as a cantilever or a balcony relative to the supports S so as to be placed on the path of advance of the basic sheets 10.

It can be seen that the track 32 is disposed on the other side of the conveying path of the basic sheets 10 with respect to the processing stations. The grippers 34 of the basic conveyors 30 each grip a single gripping edge 10A of the basic sheets 10, all the basic conveyors located on the forward path being aligned, so that all the gripping edges of the basic sheets being processed are also aligned. The possible maintenance interventions on the track and the basic conveyors are therefore also facilitated, since they are placed on the other side of the conveying path relative to the processing stations, without interfering therewith. The basic sheets have generally some flexibility. Consequently, the installation may comprise a support 50 that defines a work plane in the various processing stations, all along the conveying path of the basic sheets. In this case, this support 50 has three support rules 50A, 50B and 50C, which are disposed to carry the basic sheets 10A in the waste areas located between the containers of the different rows.

Referring again to FIG. 1, it can be seen that the installation comprises an input station E in which the thermoplastic strip 8 is fed into the conveying path of the basic sheets 10. In this case, this strip is unwound from a coil whose axis is parallel to the conveying direction F. The strip 8 is therefore fed into the conveying path by being displaced transversely to this conveying direction F. The width of the strip 8 defines the length L of the basic sheets. These basic sheets are cut at the end of the strip 8, in sections of constant length, this length defining the width of the basic sheets 10. The cutting means 60 used to cut the basic sheets are located at the inlet of the conveying plane, and comprise for example a knife 61 (see FIG. 5) whose cutting ridge is parallel to the conveying direction F, and which can be controlled in sequential vertical movement, by cooperating with a counter-knife. Conventionally, the end of the strip 8 can be fed until resting on the support 50 at the inlet of the conveying plane, before the knife is activated to separate its end resting on the support of the rest of the strip, thus forming in this end portion a basic sheet 10. The knife 61 is represented in FIG. 5 which shows, in bottom view, the cutting tool of the station 60. It is seen that this tool also comprises an upstream cutting tool 62, formed of small “star”-like knives used to cut out the waste areas in the basic sheets 10. Indeed, insofar as several containers are simultaneously formed in these areas, the junction areas between the edges of the different containers constitute waste to be eliminated. According to the present disclosure, this waste can be eliminated from the thermoplastic material, in this case the basic sheets, prior to the application of the lids for sealing the containers. Particularly, according to the disclosure, the elimination of this waste and the cutting of the basic sheets can be performed in the same cutting means 60 at the inlet of the installation.

As seen in FIG. 1, the lidding strip 19 is powered in the same manner as the strip of thermoplastic material 8. Cutting means 64 generally similar to the cutting means 60 previously described can be provided to cooperate with the strip of lidding material 19 and cut, in the latter, lidding sheets of dimension similar to those of the basic sheets and cut out at the same time, in these sheets, waste areas of lids similar to the aforementioned waste areas. The installation thus comprises an upstream cutting tool, located in the cutting means 60 for cutting out the waste areas in the basic sheets of thermoplastic material, and a downstream cutting tool located in the cutting means 64 for cutting out corresponding waste areas in the lidding sheets 11. As indicated, the upstream cutting tool 62 is part of the input station and is part of the same cutting station as the cutting tool 61.

1. An installation for producing containers by thermoforming, wherein a thermoplastic substrate is driven in a series of processing stations along a conveying direction, the processing stations comprising at least one station for heating the substrate and one station for thermoforming containers in the heated substrate, each processing station defining a processing length measured in the conveying direction,
characterized in that the installation comprising a plurality of basic conveyors for driving the thermoplastic substrate in the processing stations, the thermoplastic substrate comprising a plurality of basic sheets, each basic conveyor configured to drive, in the processing stations, a basic sheet whose length, measured in the conveying direction, is substantially equal to the processing length, the basic conveyors cooperating with a travel track and the respective movements of the basic conveyors being controlled according to respective movement control instructions generated by the control unit.

2. The installation according to claim 1, wherein the travel track forms a loop comprising a forward path on which the basic conveyors circulate to successively place the basic sheets which said basic conveyors convey in the processing stations, and a backward path, on which the basic conveyors circulate to return to the upstream of the installation.

3. The installation according to claim 1, wherein the position of the basic conveyors with respect to the processing stations is detected.

4. The installation according to claim 3, wherein each processing station has a detector configured to generate information on the position, relative to the considered processing station, of a basic sheet conveyed by a given basic conveyor, the control unit being configured to generate, based on said position information, an instruction for controlling the movement of said given basic conveyor.

5. The installation according to claim 3, wherein each basic conveyor has a detector configured to generate information on the position of the considered basic conveyor relative to a given processing station, the control unit being configured to generate, based on said position information, an instruction for controlling the movement of said considered conveyor.

6. The installation according to claim 1, wherein the movement control instructions comprise one or more of movement speed instructions and acceleration instructions.

7. The installation according to 1, wherein each basic conveyor is equipped with a basic motorization, the movement control instructions comprising instructions for activating the basic motorizations of the respective basic conveyors.

8. The installation according to claim 7, wherein the basic motorization comprises a first part of an electric motor and the track is equipped with a multiplicity of magnetic windings, selectively powered by the control unit and forming the second part of the electric motor.

9. The installation according to claim 1, wherein the processing stations are disposed on a same side along the track.

10. The installation according to claim 9, wherein the processing stations are supported by supports that are also disposed on said same side of the track.

11. The installation according to claim 1, comprising an input station in which a strip of thermoplastic material is fed along a supply direction transverse to the conveying direction and in which basic sheets whose length is defined by the width of the strip of thermoplastic material are cut in said strip of thermoplastic material.

12. The installation according to claim 1, wherein the basic conveyors comprise grippers configured to grip a single gripping edge of the basic sheets, the grippers of the basic conveyors conveying the basic sheets being all located on the same side of the track.

13. The installation according to claim 1, comprising a support for the basic sheets defining a work plane in the different processing stations.

14. The installation according to claim 1, wherein the processing stations further comprise a station for filling the thermoformed containers and a station for closing the containers by application of the lidding sheets on the basic sheets including the thermoformed containers, the installation further comprising an upstream cutting tool configured to cut out waste areas in the basic sheets prior to the application of the lidding sheets, and a downstream cutting tool configured to cut out corresponding waste areas in the lidding sheets.

15. The installation according to claim 14, comprising wherein a strip of lidding material is fed along a direction transverse to the conveying direction lidding sheets are cut in said strip of lidding material, so that the length of the lidding sheets is defined by the width of the strip of lidding material.

16. The installation according to claim 14 comprising an input station in which a strip of thermoplastic material is fed along a supply direction transverse to the conveying direction, the upstream cutting tool being part of the input station.

17. The installation according to claim 16, comprising cutting station where basic sheets are cut in said strip of thermoplastic material so that said each basic sheet has a length defined by the width of the strip of thermoplastic material, the upstream cutting tool being part of the cutting.

18. The installation according to claim 8, wherein the electric motor is of the liner servomotor type.
